(19) United States
(12) Patent Application Publication
(10) Pub. No.: US 2025/0100302 A1
(43) Pub. Date: Mar. 27, 2025

(54) PRINTER

(71) Applicant: Toshiba Tec Kabushiki Kaisha, Tokyo (JP)

(72) Inventors: Toshiya INOMATA, Yokohama Kanagawa (JP); Norio KOUZU, Mishima Shizuoka (JP); Yusuke ERA, Mishima Shizuoka (JP)

(73) Assignee: Toshiba Tec Kabushiki Kaisha, Tokyo (JP)

(21) Appl. No.: 18/673,844

(22) Filed: May 24, 2024

(30) Foreign Application Priority Data
Sep. 22, 2023 (JP) 2023-159058

(51) Int. Cl. B41J 13/036; B41J 3/407; B41J 13/10; B65H 5/06

(52) U.S. Cl. CPC B41J 13/036; B41J 3/4075; B41J 13/10; B65H 5/062; B65H 2403/7251; B65H 2404/165; B65H 2701/192

(57) ABSTRACT

A printer includes a conveyance unit, a print head, and a braking member. The conveyance unit includes first and second rollers arranged in a state of being in pressure contact with each other with a conveyance path for conveying a long printing medium interposed therebetween, and applies a conveyance force to the printing medium by rotating the first and second rollers. The print head is disposed upstream of a position where the conveyance unit applies the conveyance force in a forward direction along the conveyance path, and performs printing on the printing medium conveyed in the forward direction through the conveyance path. The braking member is disposed in contact with the second roller, is moved, by a frictional force generated by rotation of the second roller in the forward direction, to a first position where a first braking force is applied to the printing medium, and is moved, by a frictional force generated by reverse rotation of the second roller, to a second position where a second braking force larger than the first braking force is applied to the printing medium.

### CROSS-REFERENCE TO RELATED APPLICATION

This application is based upon and claims the benefit of priority from Japanese Patent Application No. 2023-159058, filed on Sep. 22, 2023, the entire contents of which are incorporated herein by reference.

### FIELD

Embodiments described herein relate generally to a printer for performing printing on a long printing medium.

### BACKGROUND

In the relate art, for example, a ribbon cartridge used and mounted in a printer includes a mechanism that prohibits reverse rotation of a roller that winds up an ink ribbon in order to prevent occurrence of slack in a portion where the ink ribbon passes through a print head. The mechanism prevents the ink ribbon from moving in a slack direction by prohibiting reverse rotation of a driven roller that presses the ink ribbon against a drive roller.

For example, in a printer that performs printing on a label sheet obtained by pasting a plurality of labels to a long strip-shaped backing sheet at equal intervals, back-feeding is performed to return the label sheet in a reverse direction so as to align each label with a print head. If the number of times of the back-feeding increases, slack may occur in the label sheet, and a jam may be erroneously detected or printing quality may be lowered.

### DESCRIPTION OF THE DRAWINGS

FIG. 1 is an external perspective view of a printer according to an embodiment according to one embodiment;

FIG. 2 is a perspective view showing a state in which a cover of a printer is opened according to one embodiment;

FIG. 3 is a perspective view of a label sheet roll according to one embodiment;

FIG. 4 is a schematic view of an internal structure of a printer according to one embodiment;

FIG. 5 is a perspective view of a peeling unit when viewed from an inner side of a case according to one embodiment;

FIG. 6 is a perspective view showing a state in which the peeling unit according to the embodiment of FIG. 5 is opened and a label sheet is attached according to one embodiment;

FIG. 7 is a perspective view showing a main part of the peeling unit according to the embodiment of FIG. 5;

FIG. 8 is a side view showing the main part of the peeling unit of FIG. 7;

FIG. 9 is a cross-sectional view of a state in which the peeling unit according to the embodiment of FIG. 5 is closed;

FIG. 10 is a view showing an operation of the peeling unit according to the embodiment of FIG. 5 when the label sheet is conveyed in a forward direction; and

FIG. 11 is a view showing an operation of the peeling unit according to the embodiment of FIG. 5 when the label sheet is back-fed.

### DETAILED DESCRIPTION

In general, according to one embodiment, a printer capable of preventing occurrence of slack of a long printing medium is provided.

A printer according to an embodiment includes a conveyance unit (e.g., a conveyor, a transporter, etc.), a print head, and a braking member (e.g., a brake, a stopper, etc.). The conveyance unit includes first and second rollers arranged in a state of being in pressure contact with each other with a conveyance path for conveying a long printing medium interposed therebetween, and applies a conveyance force to the printing medium by rotating the first and second rollers. The print head is disposed upstream of a position where the conveyance unit applies the conveyance force in a forward direction along the conveyance path, and performs printing on the printing medium conveyed in the forward direction through the conveyance path. The braking member is disposed in contact with the second roller, is moved, by a frictional force generated by rotation of the second roller in the forward direction, to a first position where a first braking force is applied to the printing medium, and is moved, by a frictional force generated by reverse rotation of the second roller, to a second position where a second braking force larger than the first braking force is applied to the printing medium.

Hereinafter, an embodiment will be described with reference to the drawings.

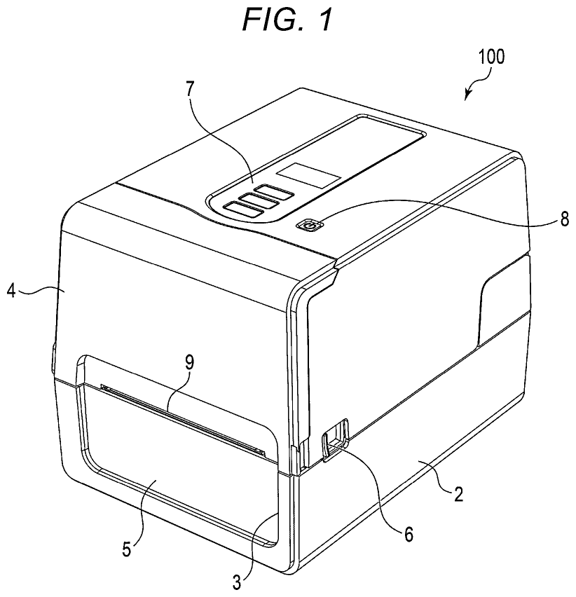

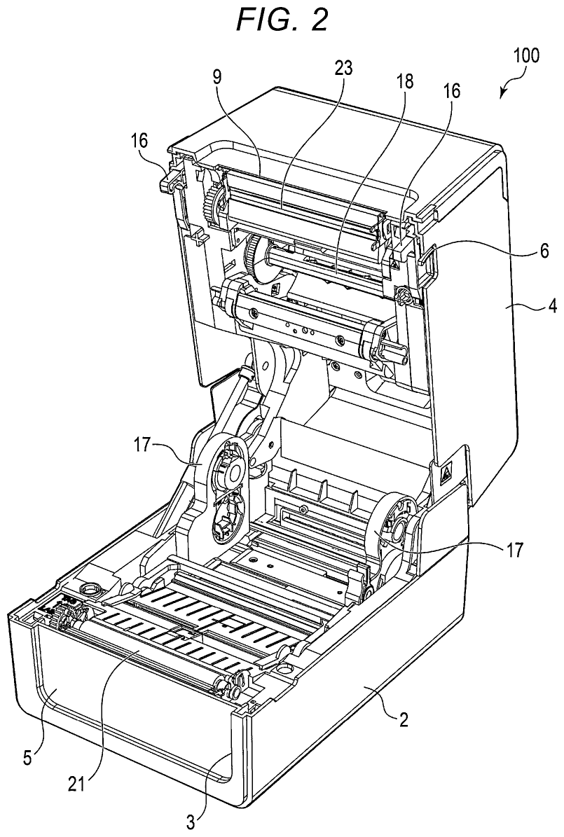

As shown in FIGS. 1 and 2, a label printer 100 (hereinafter, simply referred to as a printer 100) includes a case 2 and a cover 4. The case 2 constitutes a lower casing of the printer 100, and the cover 4 constitutes an upper casing of the printer. The cover 4 is connected to the case 2 via a hinge (not shown) provided on a rear end side. The cover 4 is pivotable between a closed position shown in FIG. 1 and an open position shown in FIG. 2. In the following description, in a state shown in FIG. 1 in which the cover 4 is disposed at the closed position, a discharge port 9 side of the printer 100 is referred to as a front side, and upper, lower, left, and right directions of the printer 100 when viewed from the front side are defined.

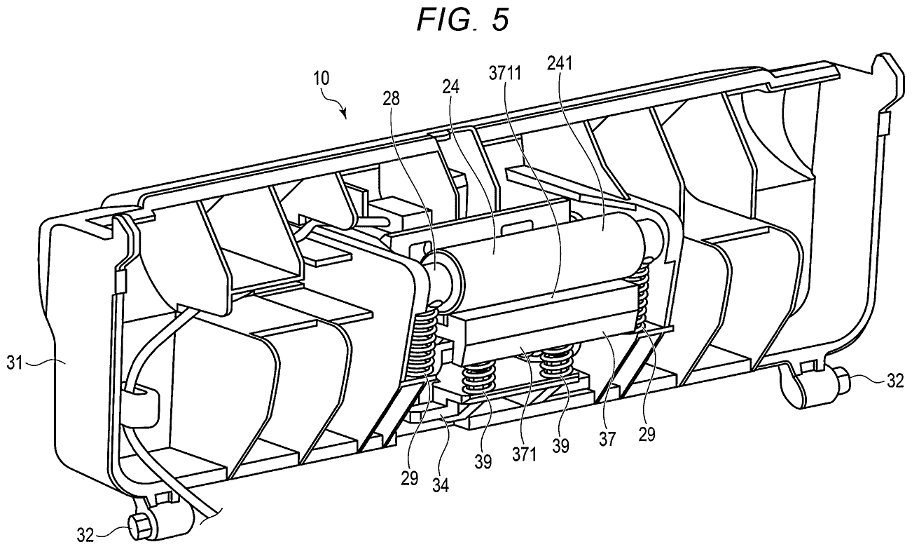

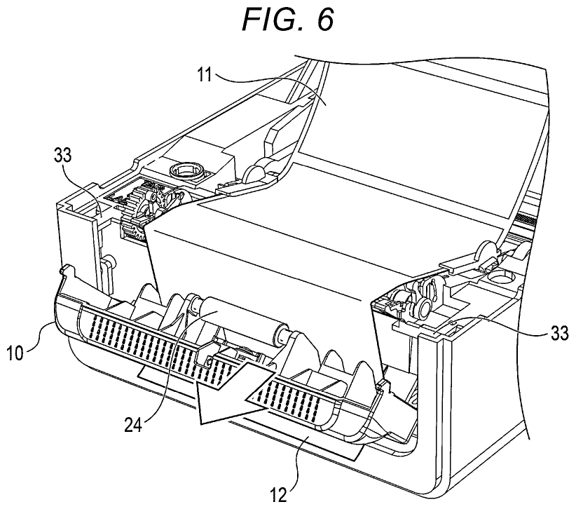

The case 2 has a rectangular box shape with an open upper side, and is provided with, in a wall portion on the front side of the case 2, a cutout portion 3 for attaching a peeling unit (e.g., a peeler, a remover, etc.) 10 (FIGS. 5 and 6) to be described later. The case 2 includes a front panel 5 attached to the cutout portion 3 when the peeling unit 10 is not attached. FIGS. 1 and 2 show a state in which the front panel 5 is attached to the cutout portion 3. The front panel 5 is attachable to and detachable from the cutout portion 3, and can be replaced with the peeling unit 10.

The cover 4 has a rectangular box shape with an open lower side. Front sides of left and right side walls of the cover 4 are each provided with an opening lever 6 for opening the cover 4 and a fixing hook 16 that is operated by operating the opening lever 6. The fixing hook 16 engages with an engaged portion of the case 2 in a state in which the cover 4 is disposed at the closed position, and locks the cover 4 at the closed position. An operation and display panel 7 and a power button 8 are provided on an upper wall of the cover 4.

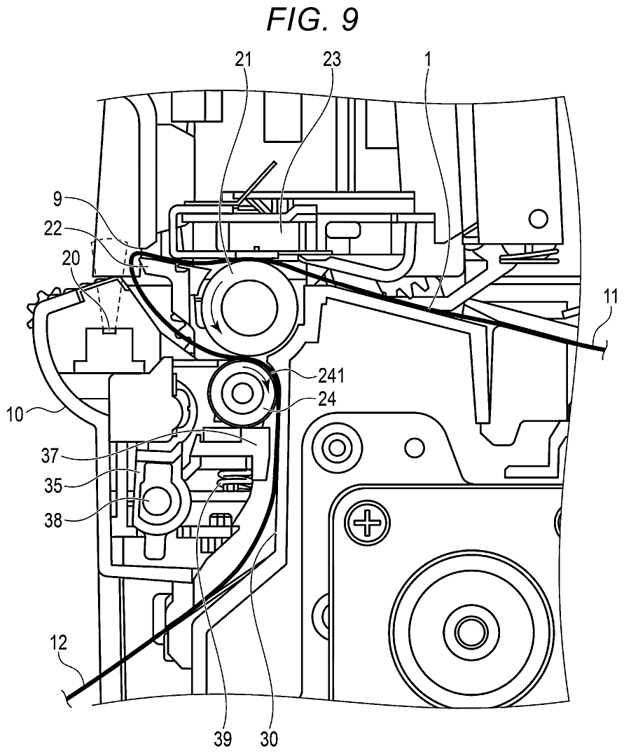

The printer 100 includes, on a front side between the front panel 5 of the case 2 and the cover 4, a slit-shaped discharge port 9 (FIG. 1) for discharging a printed label sheet 11. When the peeling unit 10 is attached to the case 2 instead of the front panel 5, the discharge port 9 is formed between the peeling unit 10 and the cover 4 in a similar manner. When the peeling unit 10 is attached, only a label 13 peeled from a backing sheet 12 is discharged through the discharge port 9. As shown in FIG. 9, the peeling unit 10 includes a label sensor 20 that detects the label 13 discharged through the discharge port 9.

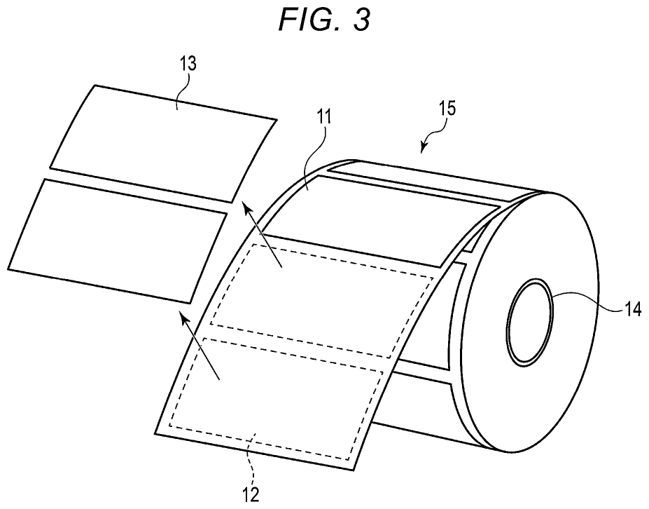

As shown in FIG. 3, the label sheet 11 to be attached in the case 2 is obtained by pasting a plurality of rectangular labels 13 at equal intervals to one surface of the long strip-shaped backing sheet 12. The label 13 has an adhesive layer on a surface at a backing sheet 12 side, is attachable to and removable from the backing sheet 12, and can be pasted to another article after being peeled off from the backing sheet 12. A label sheet roll 15 is obtained by winding the label sheet 11 around a sheet tube 14 with a surface of the backing sheet 12 to which the labels 13 are pasted facing outward. The label sheet 11 is an example of a long strip-shaped printing medium. As shown in FIG. 2, the printer 100 includes a pair of left and right sheet holders 17 for attaching the label sheet roll 15. The printer 100 perform printing on each label 13 of the label sheet 11.

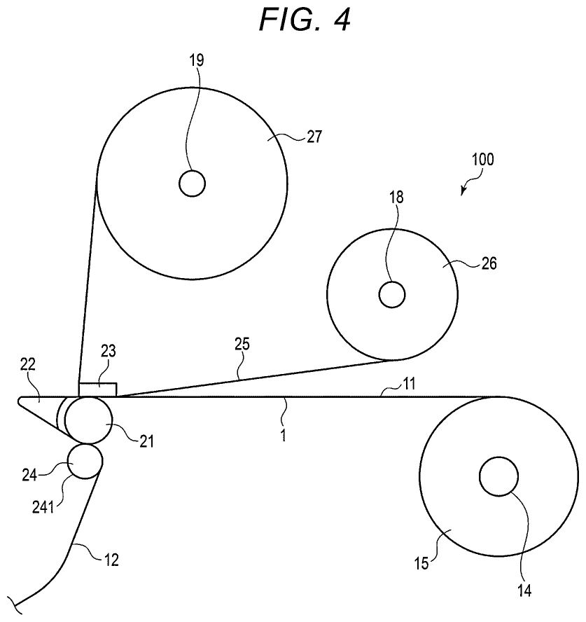

As shown in FIGS. 2 and 4, the printer 100 includes a platen roller 21 (e.g., a first roller, etc.) that applies a conveyance force in a forward direction to the label sheet 11 to pull out the label sheet 11 from the label sheet roll 15. The platen roller 21 can also apply a conveyance force to the backing sheet 12 after the label 13 is peeled off. The platen roller 21 can also rotate in a reverse direction (e.g., a direction opposite the forward direction, etc.) to back-feed the label sheet 11. The platen roller 21 is disposed on a front side in the case 2 and is adjacent to the discharge port 9. The platen roller 21 rotates to come into contact with a surface of the label sheet 11 opposite to a surface where the labels 13 are pasted to the backing sheet 12.

The printer 100 includes a conveyance path 1 for conveying the label sheet 11 pulled out from the label sheet roll 15. When the cover 4 is pivoted to the open position shown in FIG. 2, a part of the conveyance path 1 can be opened. When the peeling unit 10 is attached to the cutout portion 3 of the case 2, as shown in FIG. 6, the label sheet 11 pulled out from the label sheet roll 15 is inserted into the peeling unit 10 in a state in which the peeling unit 10 is opened to the front side. As shown in FIG. 9, the conveyance path 1 is curved along members on the path along which the label sheet 11 is conveyed.

The printer 100 includes a print head 23 that performs printing on the label sheet 11 conveyed through the conveyance path 1. The print head 23 is disposed on an opposite side (e.g., an upper side, e.g., a side opposite the platen roller 21, etc.) of the conveyance path 1 relative to the platen roller 21, and is pressed against the platen roller 21. Therefore, a conveyance force can be applied from the platen roller 21 to the label sheet 11 at a position where the print head 23 is pressed against the platen roller 21. The print head 23 is provided on a cover 4 side. The cover 4 includes a pressing spring (not shown) that presses the print head 23 against the platen roller 21.

The print head 23 can perform printing by a thermal transfer method, and can perform printing by a thermal sensitive method. If printing is performed by the thermal transfer method, as in the present embodiment, an ink ribbon 25 is interposed between the print head 23 and the label sheet 11, the ink ribbon 25 is conveyed in the same direction at the same speed as the label sheet 11, and ink of the ink ribbon 25 is melted by heat of the print head 23 and is fixed onto the label 13. If printing is performed by the thermal sensitive method, a sheet containing a color former is attached to the printer 100, and the sheet is heated by the print head 23 to develop color. If printing is performed by the thermal sensitive method, the ink ribbon 25 is removed from the printer 100.

As shown in FIG. 9, the label sheet 11 pulled out from the label sheet roll 15 passes between the platen roller 21 and the print head 23, is wound around an acute angle corner portion of a peeling guide 22, and is folded back. The peeling guide 22 is provided in the case 2 and is adjacent to a front side of the platen roller 21. The label sheet 11 wound around the corner portion of the peeling guide 22 passes between the platen roller 21 and a peeling roller 24 (e.g., a second roller, a driven roller, etc.) disposed below the platen roller 21 on an opposite side of the print head 23 in the drawing, and is discharged to the outside of the case 2.

The peeling roller 24 is a component included in the peeling unit (e.g., peeler, label remover, etc.) 10. The peeling roller 24 is separated from the platen roller 21 toward the front side in a state in which the peeling unit 10 is opened as shown in FIG. 6. When the peeling roller 24 is pivoted to the closed position shown in FIG. 9, the peeling roller 24 comes into rolling contact with the platen roller 21 with the backing sheet 12 interposed therebetween. The label sheet 11 is disposed inside the peeling unit 10 as shown in FIG. 9 in a state in which the two and three labels 13 at a leading end are peeled off from the backing sheet 12 as shown in FIG. 3.

The printed label 13 is peeled off from the backing sheet 12 by the peeling guide 22 and is discharged through the discharge port 9. The label 13 discharged from the discharge port 9 is detected by the label sensor 20. The label sensor 20 may be, for example, a transmissive optical sensor or a reflective optical sensor, but is not limited thereto.

The peeling roller 24 is pressed against the platen roller 21 by two pressing springs 29 shown in FIG. 5, and a conveyance force can be applied from the platen roller 21 to the backing sheet 12 of the label sheet 11 by a nip between the peeling roller 24 and the platen roller 21. The platen roller 21 and the peeling roller 24 are examples of a conveyance unit (e.g., a conveyor, a provider, etc.) that applies a conveyance force to the backing sheet 12 conveyed through the conveyance path 1.

The peeling guide 22 causes the backing sheet 12 of the label sheet 11 to be in slide contact with the corner portion, and folds back the backing sheet 12 in a substantially opposite direction (e.g., a direction opposite the label sheet, etc.). The peeling guide 22 peels off the label 13 from the backing sheet 12 at a waist of the label 13 that is not bent together with the backing sheet 12. The label 13 peeled off by the peeling guide 22 is discharged from the discharge port 9 and is grabbed by an operator.

As shown in FIG. 4, the printer 100 includes a supply roll 26 in which the long strip-shaped ink ribbon 25 is wound around a sheet tube, and a collection roll 27 in which the used ink ribbon 25 that passed through the print head 23 is wound around a sheet tube. The ink ribbon 25 stretched between the supply roll 26 and the collection roll 27 passes between the print head 23 and the platen roller 21 so as to sequentially overlap the plurality of labels 13 of the label sheet 11 conveyed through the conveyance path 1.

The pair of sheet holders 17 (as shown in FIG. 2) in the case 2 are pivotable and hold both ends of the sheet tube 14 of the label sheet roll 15. The cover 4 is provided therein with a feeding shaft 18 attached to the sheet tube of the supply roll 26 of the ink ribbon 25 and a rolling shaft 19 attached to the sheet tube of the collection roll 27 (not shown in FIG. 2).

The label sheet 11 may be back-fed in a direction reversed (e.g., opposite to the forward direction, a backwards direction, etc.) from the forward direction in order to align a print start position for each label 13. When the label sheet 11 is back-fed, the platen roller 21 rotates in a reverse direction to convey the label sheet 11 in a reverse direction (e.g., a direction opposite the forward direction, etc.). At this time, the print head 23 is moved to a retracted position separated a distance upward (e.g., above, etc.) from the platen roller 21, and the ink ribbon 25 is separated from the label sheet 11.

As shown in FIG. 5, the peeling unit 10 includes a casing 31 attached to the cutout portion 3 of the case 2. The casing 31 includes a pair of left and right slide shafts 32 at a lower end of the casing 31. The two slide shafts 32 are provided coaxially and protrude outward in the left-right direction in which the two slide shafts 32 are separated away from each other. The casing 31 is attached to the cutout portion 3 of the case 2 by inserting the pair of slide shafts 32 into left and right slide grooves 33 (see FIG. 6) of the cutout portion 3. The casing 31 is pivotable about the slide shafts 32 relative to the case 2. FIG. 6 shows a state in which the casing 31 of the peeling unit 10 is pivoted to the front side about the pair of slide shafts 32 and is opened.

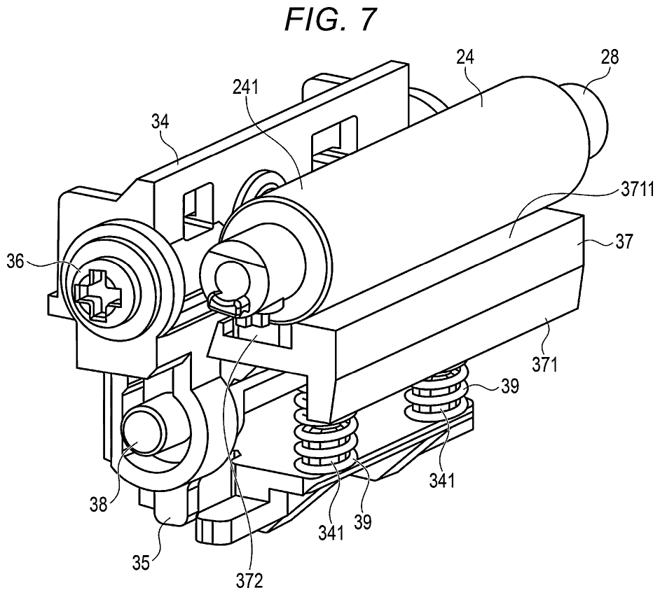

As shown in FIGS. 5, 7, and 8, the peeling unit 10 includes a holding block 34 inside the casing 31 at the center in the left-right direction. Abase end portion of an arm member 35 is attached to the holding block 34 in a manner of being pivotable about a pivot shaft 36. Abase end portion of a braking member 37 is attached to a leading end portion of the arm member 35 in a manner in which the braking member 37 is pivotable about a pivot shaft 38. As shown in FIG. 5, both ends of a rotation shaft 28 of the peeling roller 24 are rotatable and are held in the casing 31 in a manner of being movable in an upper-lower direction. There are two pressing springs 39 between the holding block 34 and the braking member 37. The pressing spring 39 is an example of an elastic member that presses the braking member 37 against the peeling roller 24.

The holding block 34 integrally includes two bosses 341 that hold lower ends of the pressing springs 39 that press the braking member 37 against the peeling roller 24. The braking member 37 has a circular hole (not shown) for receiving an upper end of the pressing spring 39. Therefore, even if the braking member 37 moves back and forth relative to the holding block 34, the pressing springs 39 do not fall off. The braking member 37 can move in the upper-lower direction and in a front-rear direction to come into contact with and separate from the peeling roller 24 as the arm member 35 pivots about the pivot shaft 36. That is, by interposing the arm member 35 between the holding block 34 and the braking member 37, the braking member 37 can be moved substantially parallel to the front-rear direction while being pressed against the peeling roller 24. The pressing springs 39 are elastically deformed to support the braking member 37 in a movable manner.

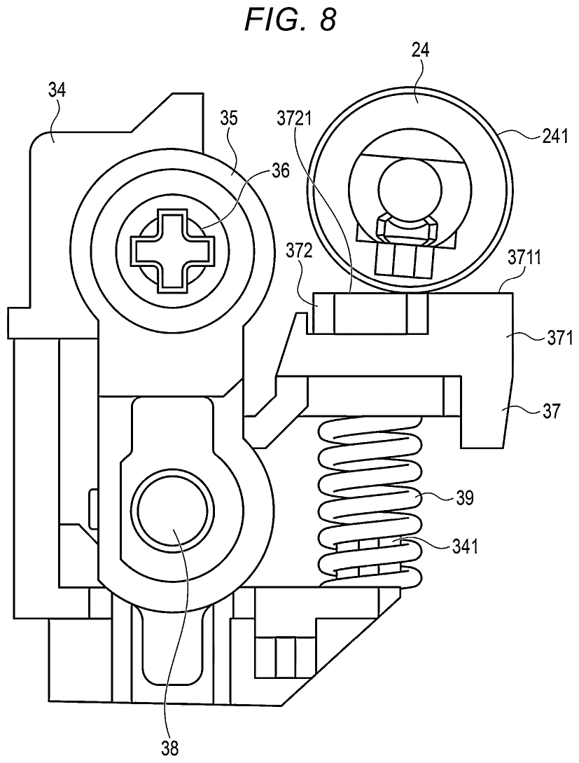

The braking member 37 includes a resin portion 371 and a rubber portion 372. As shown in FIG. 8, an upper surface 3711 of the resin portion 371 and an upper surface 3721 of the rubber portion 372 are disposed on the same horizontal plane. The resin portion 371 and the rubber portion 372 are arranged side by side in a rotation direction of the peeling roller 24. In an initial state shown in FIG. 8 in which the peeling unit 10 is disposed at the closed position, the upper surface 3721 of the rubber portion 372 is in contact with an outer peripheral surface 241 of the peeling roller 24.

FIG. 9 shows a state in which the label sheet 11 is set and the peeling unit 10 is closed. In this state, the label sheet 11 passes between the platen roller 21 and the print head 23 and is wound around the peeling guide 22, and passes between the platen roller 21 and the peeling roller 24 and is disposed along a conveyance guide 30. FIG. 9 shows a state in which the label sheet 11 is conveyed in the forward direction.

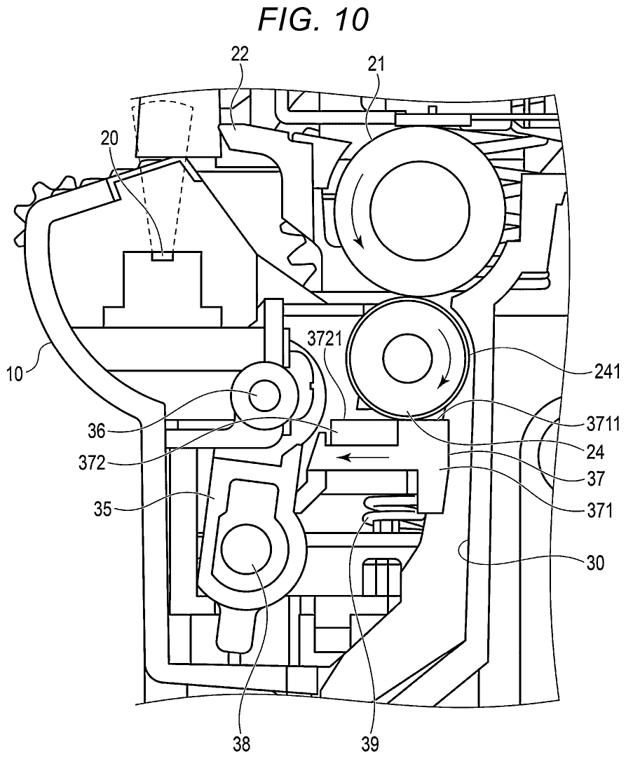

When the peeling unit 10 is closed and the label sheet 11 is conveyed in the forward direction, as shown in FIG. 10, the platen roller 21 rotates counterclockwise and the peeling roller 24 rotates clockwise. When the peeling roller 24 rotates clockwise, the braking member 37 pressed against the outer peripheral surface 241 of the peeling roller 24 is moved in a left direction in the drawing by a frictional force between the braking member 37 and the peeling roller 24, the arm member 35 swings clockwise around the pivot shaft 36, and a part of the arm member 35 comes into contact with the holding block 34 and is stopped. At this time, a position shown in FIG. 10 where the braking member 37 is stopped is a first position.

When the braking member 37 is disposed at the first position in this manner, the outer peripheral surface 241 of the peeling roller 24 comes into contact with the upper surface 3711 of the resin portion 371 of the braking member 37. In this state, when the peeling roller 24 rotates clockwise, a force in a direction of weakening the rotation of the peeling roller 24 acts on the peeling roller 24 due to a frictional force generated between the upper surface 3711 of the resin portion 371 and the outer peripheral surface 241 of the peeling roller 24 as shown in FIG. 10. This force is applied to the backing sheet 12 as a first braking force.

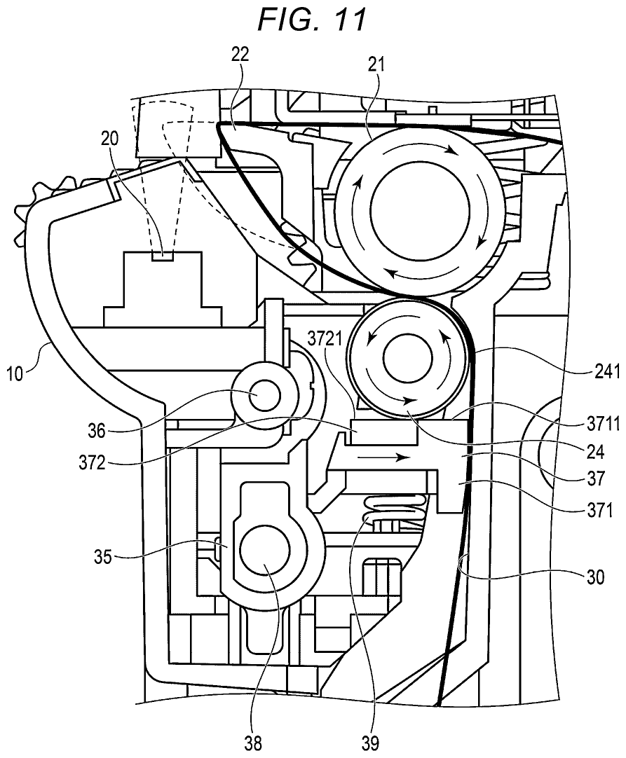

On the other hand, when the label sheet 11 is back-fed, as shown in FIG. 11, the platen roller 21 rotates clockwise, and the peeling roller 24 rotates counterclockwise. When the peeling roller 24 rotates counterclockwise, the braking member 37 pressed against the outer peripheral surface 241 of the peeling roller 24 is moved in a right direction in the drawing by a frictional force between the braking member 37 and the peeling roller 24, the arm member 35 swings counterclockwise around the pivot shaft 36, and an end portion of the resin portion 371 of the braking member 37 on a right side in the drawing is pressed against the conveyance guide 30 and is stopped. At this time, a position shown in FIG. 11 where the braking member 37 is stopped is a second position.

When the braking member 37 is disposed at the second position in this manner, the outer peripheral surface 241 of the peeling roller 24 comes into contact with the upper surface 3721 of the rubber portion 372 of the braking member 37. In this state, when the peeling roller 24 rotates counterclockwise, a force in a direction of weakening the rotation of the peeling roller 24 acts on the peeling roller 24 due to a frictional force generated between the upper surface 3721 of the rubber portion 372 and the outer peripheral surface 241 of the peeling roller 24. This force is applied to the backing sheet 12 as a second braking force which is larger than the first braking force described above.

The frictional force generated between the upper surface 3721 of the rubber portion 372 and the outer peripheral surface 241 of the peeling roller 24 is larger than the frictional force generated between the upper surface 3711 of the resin portion 371 and the outer peripheral surface 241 of the peeling roller 24. Therefore, a braking force applied to the peeling roller 24 when the upper surface 3721 of the rubber portion 372 is pressed against the outer peripheral surface 241 of the peeling roller 24 is larger than a braking force applied to the peeling roller 24 when the upper surface 3711 of the resin portion 371 is pressed against the outer peripheral surface 241 of the peeling roller 24.

When the braking member 37 is disposed at the second position, an end portion of the resin portion 371 of the braking member 37 is pressed against the conveyance guide 30 with the backing sheet 12 interposed therebetween, and a force that prevents conveyance of the backing sheet 12 acts on the backing sheet 12. This force also acts on the backing sheet 12 as a second braking force which is larger than the first braking force described above. That is, when the label sheet 11 is back-fed, a braking force is applied to the backing sheet 12 via the peeling roller 24 by bringing the backing sheet 12 into sliding contact with the rubber portion 372, and a braking force is also applied to the backing sheet 12 by pressing the resin portion 371 against the conveyance guide 30. The two types of braking forces applied to the backing sheet 12 during back-feeding act on the backing sheet 12 at different positions.

When the label sheet 11 is conveyed in the forward direction through the conveyance path 1 and printing is performed on the labels 13, it is desirable that a conveyance force applied from the platen roller 21 to the backing sheet 12 at a position where the peeling roller 24 faces the platen roller 21 is slightly larger than a conveyance force applied from the platen roller 21 to the label sheet 11 at a position where the print head 23 faces the platen roller 21. As a result, it is possible to prevent the backing sheet 12 that passed through the print head 23 from being slacked between the backing sheet 12 and the peeling roller 24, the backing sheet 12 can be brought into sliding contact with the peeling guide 22, and the label 13 can be reliably peeled off from the backing sheet 12.

On the other hand, if the conveyance force applied from the platen roller 21 to the backing sheet 12 at the position where the peeling roller 24 faces the platen roller 21 is smaller than the conveyance force applied from the platen roller 21 to the label sheet 11 at the position where the print head 23 faces the platen roller 21, there is a possibility that the backing sheet 12 that passed through the print head 23 is slacked between the peeling roller 24 and the print head 23. When such slack becomes large, there is a possibility that the slacked backing sheet 12 enters a detection range of the label sensor 20 as indicated by a broken line in FIG. 11, the slacked backing sheet 12 is erroneously detected as the label 13 that was forgotten to be taken out, and a jam is erroneously detected.

On the other hand, if the conveyance force applied from the platen roller 21 to the backing sheet 12 at the position where the peeling roller 24 faces the platen roller 21 is larger than the conveyance force applied from the platen roller 21 to the label sheet 11 at the position where the print head 23 faces the platen roller 21, a failure occurs when the label sheet 11 is back-fed. That is, in this case, a reverse conveyance force applied from the platen roller 21 to the backing sheet 12 at the position where the peeling roller 24 faces the platen roller 21 is larger than a reverse conveyance force applied from the platen roller 21 to the label sheet 11 at the position where the print head 23 faces the platen roller 21, and the backing sheet 12 returned by the peeling roller 24 may be slacked between the print head 23 and the peeling roller 24 as indicated by the broken line in FIG. 11.

Therefore, the printer 100 according to the present embodiment includes the above-described mechanism that makes a braking force applied to the peeling roller 24 during back-feeding larger than a braking force applied to the peeling roller 24 during printing. Therefore, according to the present embodiment, when printing is performed by conveying the label sheet 11 in the forward direction, the conveyance force applied from the platen roller 21 to the backing sheet 12 at the position where the peeling roller 24 faces the platen roller 21 can be made slightly larger than the conveyance force applied from the platen roller 21 to the label sheet 11 at the position where the print head 23 faces the platen roller 21, and occurrence of slack of the backing sheet 12 can be prevented. According to the present embodiment, during back-feeding, the conveyance force applied from the platen roller 21 to the backing sheet 12 at the position where the peeling roller 24 faces the platen roller 21 can be reduced to be smaller than the reverse conveyance force applied from the platen roller 21 to the label sheet 11 at the position where the print head 23 faces the platen roller 21, and occurrence of slack of the backing sheet 12 during back-feeding can also be prevented.

Therefore, according to the present embodiment, slack of the backing sheet 12 does not occur when the label sheet 11 is conveyed in the forward direction, and slack of the backing sheet 12 does not occur when the label sheet 11 is fed-back, so that the label sensor 20 does not erroneously detect the slacked backing sheet 12 and a jam does not occur, and an operating rate of the printer 100 can be improved.

While embodiments have been described, the embodiments have been presented by way of example and are not intended to limit the scope of the disclosure. The embodiments can be implemented in various other forms, and various omissions, substitutions, and changes can be made in a scope not departing from the gist of the exemplary embodiments. The embodiments and modifications thereof are included in the scope and the gist of the disclosure, and are included in a scope of the disclosure disclosed in the claims and equivalents thereof.

What is claimed is:

1. A printer comprising:
a conveyor including a first roller and a second roller each configured to rotate in a forward direction and a reverse direction, the first roller and the second roller in pressure contact with each other and a conveyance path for conveying a printing medium is interposed between the first roller and second roller, the conveyor is configured to apply a conveyance force to the printing medium by rotating each of the first roller and the second roller;
a print head disposed upstream of a position where the conveyor applies the conveyance force in a forward direction along the conveyance path, the print head configured to print on the printing medium conveyed in the forward direction through the conveyance path; and
a braking member disposed in contact with the second roller, the braking member configured to:
move, by a frictional force generated by the forward rotation of the second roller in, to a first position where a first braking force is applied to the printing medium, and
move, by a frictional force generated by the reverse rotation of the second roller, to a second position where a second braking force larger than the first braking force is applied to the printing medium.

2. The printer according to claim 1, wherein
the printing medium is a label sheet obtained by pasting a plurality of labels to a long strip-shaped backing sheet, and
the label sheet is conveyed through the conveyance path in a direction in which the labels face the print head.

3. The printer according to claim 2, wherein
the first roller is a platen roller that faces the print head with the conveyance path interposed therebetween, and
the second roller is a driven roller that presses the backing sheet passed through the print head in the forward direction against the platen roller.

4. The printer according to claim 3, wherein
the printer further comprises a peeling guide configured to peel the labels from the backing sheet, the peeling guide being disposed on a side of the conveyance path adjacent to the platen roller between a position where the print head is pressed against the platen roller and a position where the driven roller is pressed against the platen roller.

5. The printer according to claim 3, further comprising:
an elastic member configured to:
support the braking member in a movable manner between the first position and the second position, and
press the braking member against the driven roller.

6. The printer according to claim 3, further comprising:
a conveyance guide configured to:
press the backing sheet between the conveyance guide and the braking member, and
apply the second braking force to the backing sheet by moving the braking member to the second position.

7. The printer according to claim 3, wherein
the braking member includes a resin portion contacts the driven roller when the braking member is moved to the first position, and
a rubber portion that contacts the driven roller when the braking member is moved to the second position.

8. The printer according to claim 3, wherein when the platen roller and the driven roller are rotated in the forward direction,
the conveyance force applied from the platen roller to the backing sheet at a position where the driven roller faces the platen roller is greater than the conveyance force applied from the platen roller to the label sheet at the position where the print head faces the platen roller.

9. The printer according to claim 3, wherein when the platen roller and the driven roller are rotated in the forward direction,
the conveyance force applied from the platen roller to the backing sheet at a position where the driven roller faces the platen roller is less than the conveyance force applied from the platen roller to the label sheet at the position where the print head faces the platen roller.

10. The printer according to claim 1, further comprising a peeler coupled to a case of the printer and defining a discharge port, the peeler comprising a label sensor configured to sense slack in a region adjacent to the discharge port.

11. The printer according to claim 1, wherein the when the platen roller comprises a resin portion, and an upper surface of the resin portion is pressed against an outer peripheral surface of the driven roller.

12. A method of operating a printer comprising:
printing, by a print head, on a printing medium;
rotating a first roller and a second roller in a forward direction to move the printing medium along a conveyance path;
applying, by the first roller and the second roller, a conveyance force to the printing medium;
moving, by a frictional force generated by the forward rotation of the second roller in the forward direction, a braking member to a first position; and
applying a first braking force to the printing medium.

13. The method of claim 12, wherein moving the braking member to the first position further comprises:
swinging an arm member clockwise around a pivot shaft to contact a holding block.

14. The method of claim 12, wherein the braking member comprises a resin portion that contacts the second roller when the braking member is moved to the first position.

15. The method according to claim 12, further comprising:
pasting a plurality of labels to a long strip-shaped backing sheet to form a label sheet, the label sheet being the printing medium; and
providing the printing medium to the printer, wherein the label sheet is conveyed through the conveyance path in a direction in which the labels face the print head.

16. The method of claim 15, further comprising:
determining at least one of the plurality of labels is not aligned with print head for printing; and
in response to at least one label not being aligned with the print head, rotating the first roller and the second roller in a reverse direction.

17. The method of claim 16, further comprising:
moving, by a frictional force generated by the reverse rotation of the second roller, the braking member to a second position; and
applying a second braking force to the printing medium.

18. The method of claim 17, wherein the second braking force is greater than the first braking force.

19. The method of claim 17, wherein moving the braking member to the second position further comprises:
swinging an arm member counterclockwise around a pivot shaft to contact a holding block.

20. The method of claim 17, wherein the braking member includes a rubber portion that contacts the second roller when the braking member is moved to the second position.
